(19) United States
(12) Patent Application Publication
(10) Pub. No.: US 2011/0307908 A1
(43) Pub. Date: Dec. 15, 2011

(54) SYSTEMS, METHODS, AND COMPUTER PROGRAM PRODUCTS PROVIDING AN INTERFACE FOR ONE OR MORE DATABASES

(76) Inventor: James Malnati, Stillwater, MN (US)

(21) Appl. No.: 12/814,516

(22) Filed: Jun. 14, 2010

(51) Int. Cl. G06F 9/54

(52) U.S. Cl. 719/328

(57) ABSTRACT

A computer program product having a computer readable medium tangibly recording computer program logic is disclosed. The computer program product includes code to receive user input requesting access to a first database of a plurality of databases and code to load a file in a process written in unmanaged code, where the file creates a Component Object Model (COM) callable wrapper. The computer program product further includes code to make a method call to the COM callable wrapper requesting access to the first database and code to make an Application Programming Interface (API) call from the COM callable wrapper to an object oriented interface of the first database in response to the method call.

### BACKGROUND OF THE INVENTION

Business Information Server (BIS) is a database management and reporting system available from Unisys Corporation. It allows a user to manage and create reports from disparate databases, such as Microsoft SQL Server® databases, OLE DB, ODBC, and Oracle® databases.

Currently, BIS has a relational interface commonly referred to as Mapper®. Mapper® accesses databases through a Transact-SQL interface to Microsoft SQL Server®. Specifically, BIS uses DB-Library for C Application programming Interfaces (APIs). DB-Library has C functions and macros that facilitate interaction between an application and Microsoft SQL Server®, and C is unmanaged code.

However, use of the DB-Library is deprecated by Microsoft starting with Microsoft SQL Server® 2005. Microsoft suggests migrating to a Native MS SQL Server interface using ADO.NET, where ADO.NET is part of the .NET framework and uses managed code, such as C++ or C#. Given that BIS's native interface access to Microsoft SQL Server® databases exclusively utilizes the DB-Library to execute the Transact-SQL commands to Microsoft SQL Server®, the impact of this development on BIS customers calls for a modernization path to a comparable interface.

### BRIEF SUMMARY OF THE INVENTION

In a first aspect, a computer program product having a computer readable medium tangibly recording computer program logic is disclosed. The computer program product includes code to receive user input requesting access to a first database of a plurality of databases and code to load a file in a process written in unmanaged code, where the file creates a Component Object Model (COM) callable wrapper. The computer program product further includes code to make a method call to the COM callable wrapper requesting access to the first database and code to make an Application Programming Interface (API) call from the COM callable wrapper to an object oriented interface of the first database in response to the method call.

In another aspect, a computer-implemented method is disclosed. The method includes receiving user input requesting access to a first database of a plurality of databases and loading a file in a process written in unmanaged code. The file creates a Component Object Model (COM) callable wrapper. The method further includes making a method call to the COM callable wrapper requesting access to the first database and making an Application Programming Interface (API) call from the COM callable wrapper to an object oriented interface of the first database in response to the method call.

In one aspect, a computer-implemented system is disclosed. The system includes means for receiving user input requesting access to a first database of a plurality of databases and means for loading a file in a process written in unmanaged code. The file creates a Component Object Model (COM) callable wrapper. The system also has means for making a method call to the COM callable wrapper requesting access to the first database and means for making an Application Programming Interface (API) call from the COM callable wrapper to an object oriented interface of the first database in response to the method call.

In yet another aspect, a computer-implemented system is disclosed. The system includes a first functional unit that receives user input requesting access to a first database of a plurality of databases and a second functional unit that loads a file in a process written in unmanaged code. The file creates a Component Object Model (COM) callable wrapper. The system also has a third functional unit that makes a method call to the COM callable wrapper requesting access to the first database and a fourth functional unit that makes an Application Programming Interface (API) call from the COM callable wrapper to an object oriented interface of the first database in response to the method call.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of an operational system for interacting with databases according to one example embodiment.

FIG. 2 is a block diagram of the interfaces of the operational system of FIG. 1 according to one example embodiment.

FIG. 3 is an illustration of exemplary flow according to one embodiment.

### DETAILED DESCRIPTION OF THE INVENTION

Various embodiments provide a new interface for accessing databases using unmanaged code, such as DB-Library. Specifically, various embodiments include an ADO.NET API logic module that creates objects that the unmanaged code can use to access Microsoft SQL Server® through ADO.NET.

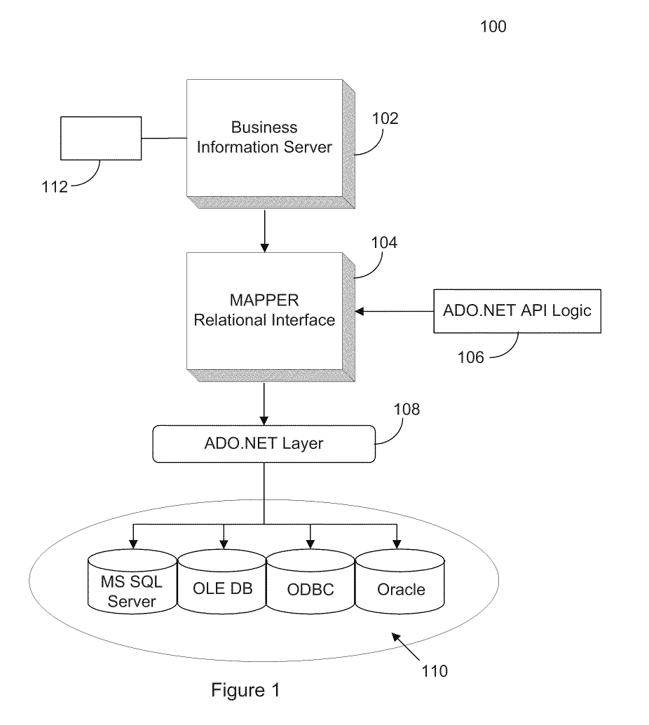

FIG. 1 is a block diagram of an operational system 100 for interacting with databases according to one example embodiment. Operational system 100 includes BIS 102, which interfaces with a user and performs tasks, such as login, logout, update, delete, database requests, and the like. BIS 102 includes mapping unit 104, which provides access to several disparate databases 110 including, but not limited to, Microsoft SQL Server®, OLE DB, ODBC, and Oracle™. Mapping unit 104 has ADO.NET API logic module 106, which allows unmanaged code processes in mapping unit 104 (DB-Library) to access databases 110 through ADO.NET layer 108, as explained in mode detail below. In one example, from the perspective of a BIS user, the configuration and BIS user interface 112 behave in a manner similar to the current BIS database interfaces so that BIS users do not have to learn an entirely new user interface.

ADO.NET API logic module 106 creates a COM Callable Wrapper (CCW), in the form of a .DLL file, which exposes access to the .NET framework. The CCW directly communicates with the ADO API interfaces of databases 110—ODBC, OLE DB, Native Oracle, and Native Microsoft SQL Server®. The MRIM.exe process (unmanaged code) in mapping unit 104 loads this newly created .DLL file and utilizes entry points to the .NET connection object. The entry points are in the form of API calls made from a connection object instantiated in the MRIM.exe process. The connection object indirectly accesses the ADO databases via method calls to the .DLL file.

A new primary database interface type of “ADONET” is created and treated by the MRIM.exe process and the RDI/MRIDBA scripts in a manner that very similarly mirrors the handling of the ODBC database. The ADONET database type will be stored in the “DBMS type” field of Network Configuration Report that is accessible by a human user.

Depending on the subtype of the database being accessed, the MRIM.exe process calls one of four objects from the COM Callable Wrapper DLL. The valid subtypes are stored in the “Network Path Name” of the Network Configuration Report and utilized by the MRIM.exe process. In this example, four valid subtypes include DOSQL, ADOODBC, ADOOLEDB, ADOORACLE, each one corresponding to one of the four types of databases.

Depending on the database subtype being utilized, additional connection information may be required by the COM Callable Wrapper DLL. Mapping unit 104 passes this information to the connection object via the API call. The information needed for each subtype is placed in the “Additional Network Information” of a Network Configuration Report in user interface 112. Information for each subtype is outlined below:

ADOSQL: Uses a specified database and server, in the form of <database>@<server>.

ADOODBC: Uses a Data Source Name, in the form of <DSN>

ADOOLEDB: Uses a configuration UDL file, in one of two forms <UDL filename>.udl or <Fully qualified path>l<UDL filename>.udl. If the <UDL filename>.udl form is utilized:

1) This file exists in the default location: C:\program files\common files\systemlole dbldata links\, and 2) The directory of the <UDL filename>.udl file must be specified in the “UDLDIR” variable of the appropriate MRIMPARM file.

ADOORACLE: Requires an Oracle SID in the form of <SID>.

Mapping unit 104 extracts column data types and sizes, based on the database subtype. The ADO.NET data types are not utilized. This provides the smoothest migration path from Microsoft SQL Server® native interface to the ADO.NET interface.

A new .DLL file is installed with BIS 102, which the MRIM.exe process loads and utilizes to access the ADO.NET databases. The .DLL file is located in a shared folder and may not be command line registered. In this example, no additional libraries are used to load the .DLL file.

The database registration for remote and local databases in mapping unit 104 are updated to allow for configuring local and remote ADONET databases. Specific help and database information is extracted, depending on the database subtype configured.

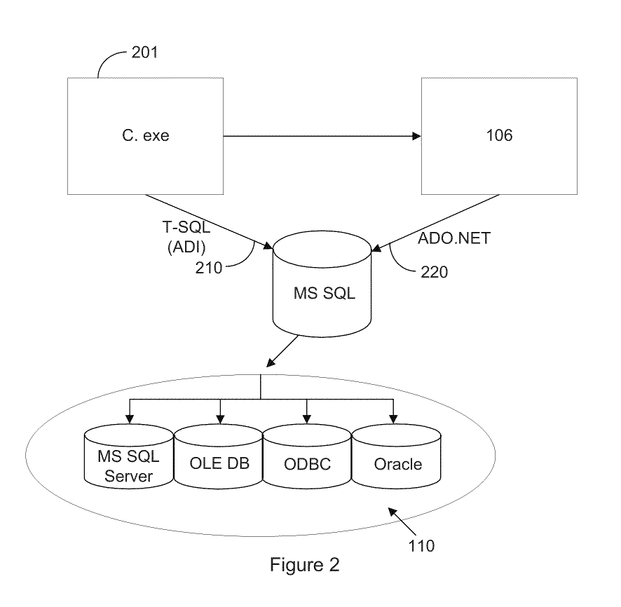

FIG. 2 is a block diagram of the interfaces of operational system 100 according to one example embodiment. MRIM.exe process 201 has interface 210 with Microsoft SQL Server®, through which databases 110 are accessed. Interface 210 is a T-SQL interface, and, as explained above, may not be supported by future releases of Microsoft SQL Server®. FIG. 2 also shows ADO.NET API logic module 106. MRIM.exe process 201 interacts with ADO.NET API logic module 106 to use interface 220. In this example, interface 220 is an interface in C++ which creates objects that “unmanaged code” can use to access Microsoft SQL Server® through ADO.Net, which uses managed, object-oriented code. When using interface 220, databases 110 are accessed through Microsoft SQL Server®.

A unique challenge of some embodiments is that there is no current third party method to make an API call to ADO.NET which can cleanly interface with a legacy MRIM.exe process (e.g., process 201) that is written in C. In previous data access methods, MRIM.exe process 201 could simply call the database client with the required third party API and access all database operations via that API. By implementing ADO.NET interface 220, an initial step is to internally create a client interface to expose the ADO.NET functionality. Interface 220 behaves as a pseudo COM client (COM Callable Wrapper). Since the C language cannot create the necessary objects to utilize the COM Callable Wrapper (CCW), MRIM.exe process 201 utilizes a module written in C++ that creates an object within MRIM.exe process 201 that can then call the “client” (CCW) interface, which exposes the ADO.NET functionality.

Further complicating the situation is the fact that ADO.NET exposes a single generic interface for all four databases (Microsoft SQL Server®, ODBC, OLE DB, and Oracle®) 110. The limitation ADO.NET is that it is designed for embedded SQL statements and operations, where the structure and format of the underlying database is known during design of the interface. Unfortunately, BIS access to databases 110, via MRIM.exe process 201 is ad hoc, in that nothing is known about the underlying databases 110. The calls to collect the necessary information (e.g., Data Dictionary Information) are unique calls based on an object's specific database type. Accordingly, interface 220 has four objects, where each object is designed for a specific underlying database type so that all database types are adequately supported. The restrictions disallow the use of the generic System.Data namespace, which in turn necessitates the implementation of the database specific System.Data.Oracle, System.Data.SQL, System.Data.ODBC, and System.Data.OLEDB namespaces.

ADO.NET API logic module 106 creates an MRIM_LIBRARY.dll file that makes the direct ADO.NET interface calls to the required database interface (Microsoft SQL Server®, ODBC, OLE DB, and Oracle®). The references explicitly access the System, System.Data, System.Data.Oracle, System.Data.SQL, System.Data.ODBC, and System.Data.OLEDB namespaces. The files are coded in C#.

MRIIVI_LIBRARY.dll is contained in the MRIM_LIBRARY project, is written in C#, and creates the MRIM objects that expose the necessary methods and properties used to Logon, Fetch, Insert, Update, Delete, and Logoff specific databases via ADO.NET interface calls. MRIIVI_LIBRARY.dll is dynamically loaded by MRIM.exe process 201 and is called from a transient C++ module (HND-ADONET.epp).

An HND-ADONET.cpp module is written in C++ and creates objects within MRIM.exe process 201 that make the API calls to the MRIM_LIBRARY.dll. The HND-ADONET.cpp module is modeled after an OLE DB interface, i.e., HND-OLEDB.cpp.

An MRI-ADONET.c module is written in C and utilized to collect the Data Dictionary Information for tables utilized in SQL statements. In addition, data conversion from numeric to string occurs in this module. The MRI-ADONET.c module provides the equivalent functionality that MRI-OLEDB.c provides for OLEDB.

The run MRIDBA and RDI scripts in MRIM.exe process 201 are updated so that users can register Local and Remote ADO.NET databases. The different database types, (e.g., MS SQL, ODBC, OLE DB, and Oracle) usually require specific information in order to logon via the ADO.NET interface. There is no generic way to logon to all databases via a single overloaded .NET method. Accordingly, the MRIM_LIBRARY.dll is fed the type of database interface, below the ADO.NET layer, in order to instantiate the correct object interface.

The MRIDBA script in MRIM.exe process 201 collects the logon information during the database configuration process. Upon completion of this process, the MRIDBA script stores the required information in a database report, placing the ADO.NET type in the Network Path Name and the additional logon information in the Additional Network Information field. Such action facilitates use of different databases each having different logon information. Much functionality for ADO.NET in this embodiment behaves in a manner that mirrors ODBC. For example, users are able to retrieve a list of tables and views via a generic SELECT statement regardless of the type of underlying database.

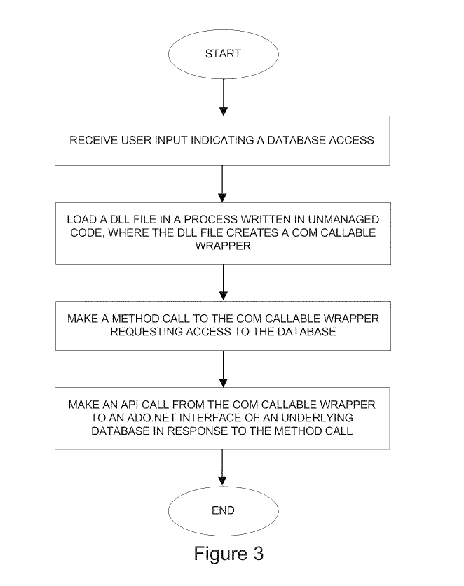

FIG. 3 is an illustration of exemplary flow 300 according to one embodiment. Process 300 may be performed, for example, by one or more computers executing code to implement BIS allowing user access to a variety of different databases. The one or more computers may be running MRIM.exe process (201 of FIG. 2). Process 300 begins at 310.

In block 301, user input is received, which requests database access. For example, the user input may request to logon, to change a database entry, to generate a report, and/or the like. Process 300 uses an ADO.NET interface to the databases that is different from a database interface used by conventional BIS systems. However, in some embodiments, the actions on the part of a user may be similar to actions used with conventional BIS systems.

In block 302, a .DLL file is loaded in a process written in unmanaged code. The .DLL file creates a COM callable wrapper, which facilitates access to a managed resource (in this example, Microsoft SQL Server® through ADO.NET) from a process written in unmanaged code. In some embodiments, there is a .DLL file for each database type, such that the appropriate DLL file is selected based on which database is being accessed. [***Inventors—Is the previous sentence, regarding .DLL files for each database type, correct?]

In block 303, a method call is made to the COM callable wrapper requesting access to the database. For example, a .NET connection object for a specific database is instantiated in a MRIM.exe process, and the .NET connection object makes a method call to the COM callable wrapper consistent with the user input requesting access. In some embodiments, there is a .NET connection object for each of the underlying databases, where the particular .NET connection object that corresponds to the desired database is instantiated.

In block 304, the COM callable wrapper makes an API call to an ADO.NET interface of an underlying database in response to the method call. In this manner, the MRIM.exe process accesses the database. Process 300 ends at 320.

The scope of embodiments is not limited to the specific embodiment shown in FIG. 3. Some embodiments may add, omit, rearrange, or modify process 300, depending on the particular application.

Various embodiments may include one or more advantages over conventional systems. For instance, conventional BIS systems do not offer a technique to provide access to resources using managed code. Various embodiments provide functionality to provide access to the resources that use managed code with few modifications to a conventional MRIM.exe process of the BIS system.

Furthermore, while the embodiments above are described with reference to the BIS system, it should be noted that the scope of embodiments is not so limited. For instance, other designs may be adapted for use with any suitable database access technology by adding one or more functional modules consistent with the disclosure above. Furthermore, the scope and embodiments are not limited to any particular database types.

It is recognized that the above systems and methods operate using computer hardware and software in any of a variety of configurations. Such configurations can include computing devices, which generally include a processing device, one or more computer readable media, and a communication device. Other embodiments of a computing device are possible as well. For example, a computing device can include a user interface, an operating system, and one or more software applications. Several example computing devices include a personal computer (PC), a laptop computer, or a personal digital assistant (PDA). A computing device can also include one or more servers, one or more mass storage databases, and/or other resources.

A processing device is a device that processes a set of instructions. Several examples of a processing device include a microprocessor, a central processing unit, a microcontroller, a field programmable gate array, and others. Further, processing devices may be of any general variety such as reduced instruction set computing devices, complex instruction set computing devices, or specially designed processing devices such as an application-specific integrated circuit device.

Computer readable media includes volatile memory and non-volatile memory and can be implemented in any method or technology for the storage of information such as computer readable instructions, data structures, program modules, or other data. In certain embodiments, computer readable media is integrated as part of the processing device. In other embodiments, computer readable media is separate from or in addition to that of the processing device. Further, in general, computer readable media can be removable or non-removable. Several examples of computer readable media include, RAM, ROM, EEPROM and other flash memory technologies, CD-ROM, digital versatile disks (DVD) or other optical storage, magnetic cassettes, magnetic tape, magnetic disk storage or other magnetic storage devices, or any other medium that can be used to store desired information and that can be accessed by a computing device. In other embodiments, computer readable media can be configured as a mass storage database that can be used to store a structured collection of data accessible by a computing device.

A communications device establishes a data connection that allows a computing device to communicate with one or more other computing devices via any number of standard or specialized communication interfaces such as, for example, a universal serial bus (USB), 802.11a/b/g network, radio frequency, infrared, serial, or any other data connection. In general, the communication between one or more computing devices configured with one or more communication devices is accomplished via a network such as any of a number of wireless or hardwired WAN, LAN, SAN, Internet, or other packet-based or port-based communication networks.

The above specification, examples and data provide a complete description of the manufacture and use of the composition of the invention. Since many embodiments of the invention can be made without departing from the spirit and scope of the invention, the invention resides in the claims hereinafter appended.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer program product having a computer readable medium tangibly recording computer program logic, the computer program product comprising:
code to receive user input requesting access to a first database of a plurality of databases;
code to load a file in a process written in unmanaged code, where the file creates a Component Object Model (COM) callable wrapper;
code to make a method call to the COM callable wrapper requesting access to the first database; and
code to make an Application Programming Interface (API) call from the COM callable wrapper to an object oriented interface of the first database in response to the method call.

2. The computer program product of claim 1 in which the file comprises a .DLL file.

3. The computer program product of claim 1 in which the code to make a method call comprises:
code to instantiate a connection object adapted for use with the first database but not adapted for use with other databases of the plurality of databases.

4. The computer program product of claim 1 in which the object oriented interface comprises:
an ADO.NET interface.

5. The computer program product of claim 1 in which the object oriented interface comprises:
a C++ interface.

6. The computer program product of claim 1 in which the object-oriented interface is based on managed code.

7. A computer-implemented method comprising:
receiving user input requesting access to a first database of a plurality of databases;
loading a file in a process written in unmanaged code, where the file creates a Component Object Model (COM) callable wrapper;
making a method call to the COM callable wrapper requesting access to the first database; and
making an Application Programming Interface (API) call from the COM callable wrapper to an object oriented interface of the first database in response to the method call.

8. The method of claim 7 in which the file comprises a .DLL file.

9. The method of claim 7 in which making a method call comprises:
instantiating a connection object adapted for use with the first database but not adapted for use with other databases of the plurality of databases.

10. The method of claim 7 in which the object oriented interface comprises:
an ADO.NET interface.

11. The method of claim 7 in which the object oriented interface comprises:
a C++ interface.

12. The method of claim 7 in which the object-oriented interface is based on managed code.

13. A computer-implemented system comprising:
means for receiving user input requesting access to a first database of a plurality of databases;
means for loading a file in a process written in unmanaged code, where the file creates a Component Object Model (COM) callable wrapper;
means for making a method call to the COM callable wrapper requesting access to the first database; and
means for making an Application Programming Interface (API) call from the COM callable wrapper to an object oriented interface of the first database in response to the method call.

14. The system of claim 13 in which the file comprises a .DLL file.

15. The system of claim 13 in which the means for making a method call comprises:
means for instantiating a connection object adapted for use with the first database but not adapted for use with other databases of the plurality of databases.

16. The system of claim 13 in which the object oriented interface comprises:
an ADO.NET interface.

17. The system of claim 13 in which the object oriented interface comprises:
a C++ interface.

18. The system of claim 13 in which the object-oriented interface is based on managed code.

19. A computer-implemented system comprising:
a first functional unit that receives user input requesting access to a first database of a plurality of databases;
a second functional unit that loads a file in a process written in unmanaged code, where the file creates a Component Object Model (COM) callable wrapper;
a third functional unit that makes a method call to the COM callable wrapper requesting access to the first database; and
a fourth functional unit that makes an Application Programming Interface (API) call from the COM callable wrapper to an object oriented interface of the first database in response to the method call.

20. The system of claim 19 in which the file comprises a .DLL file.

21. The system of claim 19 in which the third functional unit comprises:
a fifth functional unit that instantiates a connection object adapted for use with the first database but not adapted for use with other databases of the plurality of databases.

22. The system of claim 19 in which the object oriented interface comprises:
an ADO.NET interface.

23. The system of claim 19 in which the object oriented interface comprises:
a C++ interface.

24. The system of claim 19 in which the object-oriented interface is based on managed code.
